(19) United States
(12) Patent Application Publication
(10) Pub. No.: US 2014/0216205 A1
(43) Pub. Date: Aug. 7, 2014

(54) Crank Assembly

(71) Applicant: Sergio Landau, Laguna Niguel, CA (US)

(72) Inventor: Sergio Landau, Laguna Niguel, CA (US)

(21) Appl. No.: 14/028,443

(22) Filed: Sep. 16, 2013

Related U.S. Application Data
(63) Continuation-in-part of application No. 13/792,191, filed on Mar. 11, 2013.
(60) Provisional application No. 61/761,216, filed on Feb. 5, 2013.

(51) Int. Cl. B62M 3/04

(52) U.S. Cl. CPC B62M 3/04
USPC 74/594.3

(57) ABSTRACT

The invention is a crank assembly designed to allow the length of the crank arms to vary throughout the revolution of the crank. A spindle is attached to the bottom bracket assembly of a bicycle. The spindle is comprised of a cylindrical shaft with a mating feature at each end. A first crank arm assembly is attached to the spindle's left mating feature. The left crank arm assembly includes the crank arm, slider assembly, bearing, track, and pedal. Next, a second crank arm assembly is attached to the spindle's right mating feature. The right crank arm assembly includes the chain ring base, bearing, track, crank arm, slider assembly, pedal, and chain ring. Finally, the trajectory of the pedals in this invention follows a unique curve designed to allow the optimum expansion and contraction of the crank arms coinciding with the optimum amount of torque and angular speed.

### CROSS-REFERENCE TO RELATED APPLICATIONS

The present application is related to and claims priority from prior provisional application Ser. No. 61/761,216 filed Feb. 5, 2013 and non-provisional application Ser. No. 13/792,191 filed Mar. 11, 2013 the contents of which are incorporated herein by reference.

### FIELD OF THE INVENTION

This invention is in the field of human powered machines, and in particular a crank assembly, such as a crank assembly for bicycles.

### BACKGROUND OF THE INVENTION

Human-powered machines, such as bicycles, have played important roles in human lives since the invention of the wheel. Various forms of human-powered cycles, such as bicycles, tricycles, and scooters are used every day for recreation and work in just about every society throughout the world. Even a small enhancement that results in weight reduction, size reduction, cost reduction, increased energy conversion, increased speed, or ease of use will have a drastic impact.

The basic design of a bicycle consists of a frame, a pair of wheels, a steering mechanism, and a crank assembly. The traditional crank system consists of crank with pedals coupled by a chain to a rear gear that is attached to the rear wheel. The rider rotates the cranks system to propel the bicycle forward. The traditional crank system includes two diametrically opposed crank arms with fixed lengths. However, the crank system with fixed-length crank arms is not optimally efficient.

Bicycles are generally efficient, comfortable, and fast on flat or downhill surfaces. However, for uphill, rough terrain, mountain bike riding, or whenever there is a gain in elevation, bicycles with fixed-length crank arms become inefficient. The same issue also exists in other types of crank driven machines. It becomes necessary to downshift the gears, and apply greater force onto the pedals to increase torque. The downshifting and the increased effort demanded cause a loss in momentum, making the bike move slower and therefore less efficiently.

This invention provides a novel solution for an optimally powered crank system for a vehicle, or machine. This invention enables a crank system that is more efficient than a traditional crank system. This invention includes a system and methods to that optimizes the rotating speed of the crank arms and the torque in the down-stroke without requiring the application of more force. This invention includes a novel system and method to optimize the length of each crank arm throughout the revolution of the crank assembly.

### BRIEF SUMMARY OF THE INVENTION

One embodiment of the invention is a crank assembly designed to allow the length of the crank arms to vary throughout the revolution of the crank. The invention is designed such that it can be used with existing vehicles, or machines. One example of such a vehicle, or machine, is a bicycle, however the invention may also be used with other crank driven machines.

First, the spindle is attached to the bottom bracket assembly of a bicycle. The spindle is comprised of a cylindrical shaft with a mating feature at each end. A first crank arm assembly (e.g. left crank arm assembly) is attached to the spindle's left mating feature. The left crank arm assembly includes the crank arm, slider assembly, bearing, track, and pedal. Next, a second crank arm assembly (e.g. right crank arm assembly) is attached to the spindle's right mating feature. The right crank arm assembly includes the chain ring base, chain ring holder, bearing, track, crank arm, slider assembly, pedal, and chain ring.

The slider includes features that allow the slider to collapse and expand along the rails. The slider may also include friction-reducing features. Each crank arm assembly also includes at least two track rollers mounted to the side of each crank arm assembly. The track rollers are designed to reduce friction and counter inertial forces associated with the crank arm assembly sliding along the tracks. Next, the assembly includes two tracks mounted on each side of the bike frame. The tracks are mounted to the bike frame with mounting brackets. The tracks are used to control the length of the crank arms at each angular position. The shape of each track is designed to coincide with the optimum crank arm length at the various angular positions as the crank arm rotates through a complete revolution. Finally, the trajectory of the pedals in this invention follows a unique curve designed to allow the optimum expansion and contraction of the crank arms coinciding with the optimum amount of torque and angular speed.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a figure illustrating the various pedal efficiency zones of a typical crank assembly in accordance with the teachings of the present invention;

FIG. 2 is a figure showing crank length pattern optimized for faster rotation and torque at various angles of rotation in accordance with the teachings of the present invention;

FIG. 3 is an illustration of a bicycle frame with a crank assembly in accordance with the teachings of the present invention;

FIG. 4 is an illustration of a spindle in accordance with the teachings of the present invention;

FIG. 5 is an illustration of a portion of a crank arm assembly including the spindle, slider, crank arm, and bearing in accordance with the teachings of the present invention;

FIG. 6 is an illustration of a portion of a crank arm assembly including the spindle, slider, crank arm, track, and bearing in accordance with the teachings of the present invention;

FIG. 7 is an illustration of a portion of a crank arm assembly including the spindle, slider, crank arm, pedal, and bearing in accordance with the teachings of the present invention;

FIG. 8 is an illustration of a crank arm assembly including the left side of the crank arm assembly and a portion of the right side including the chain ring base and chain ring holder in accordance with the teachings of the present invention;

FIG. 9 is an illustration of a crank arm assembly including the left side of the crank arm assembly and a portion of the right side including the chain ring base, crank arm, and chain ring holder in accordance with the teachings of the present invention;

FIG. 10 is an illustration of a crank arm assembly including the left side of the crank arm assembly and a portion of the right side including the chain ring base, crank arm, track, and chain ring holder in accordance with the teachings of the present invention;

FIG. 11 is an illustration of a crank arm assembly including the left side of the crank arm assembly and a portion of the right side including the chain ring base, crank arm, track, slider, pedal, and chain ring holder in accordance with the teachings of the present invention;

FIG. 12 is an illustration of slider in accordance with the teachings of the present invention;

FIG. 13 is a cross sectional view of one side of the crank arm assembly including a close up view of the rear and front rollers in accordance with the teachings of the present invention;

FIG. 14 is an illustration of the crank arm in accordance with the teachings of the present invention.

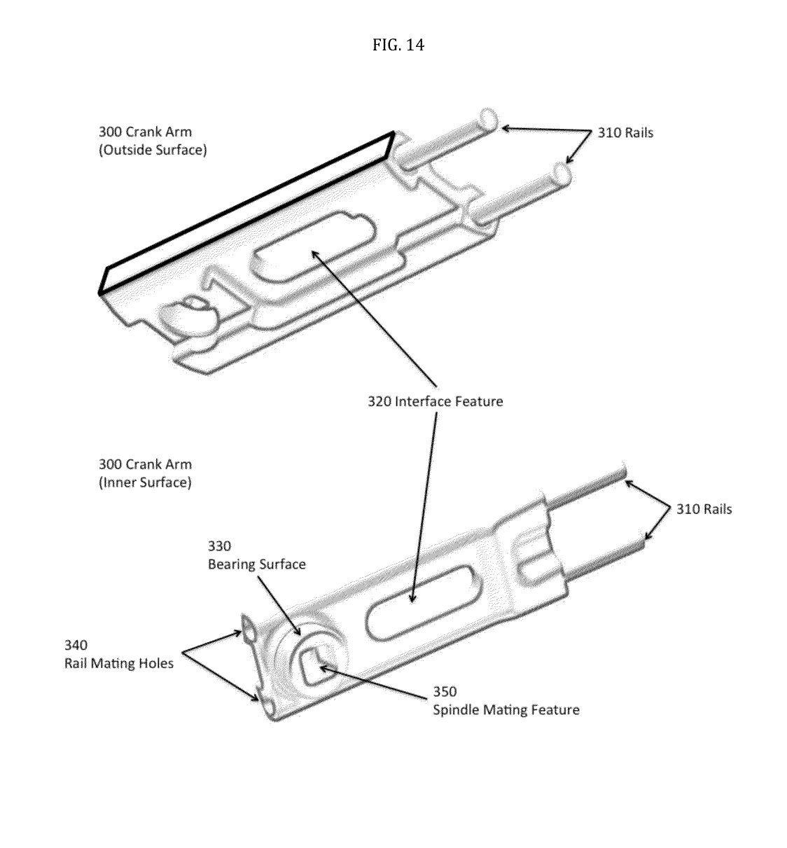

### DETAILED DESCRIPTION OF THE INVENTION

The following describes the details of the invention. Although the following description will proceed with reference being made to illustrative embodiments, many alternatives, modifications, and variations thereof will be apparent to those skilled in the art. Accordingly, it is intended that the claimed subject matter be viewed broadly. Examples are provided as reference and should not be construed as limiting. The term “such as” when used should be interpreted as “such as, but not limited to.”

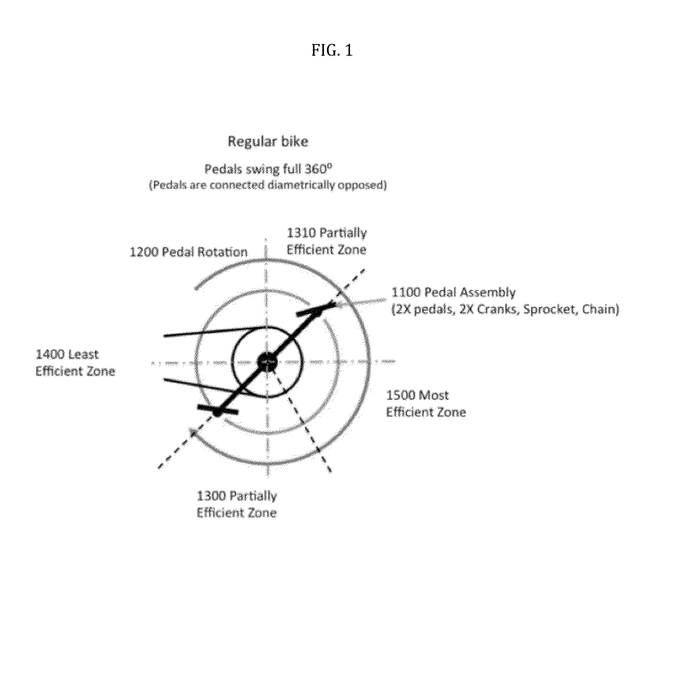

FIG. 1 illustrates the efficiency of a pedal rotation 1200 of a regular crank assembly 1100 with fixed-length crank arms. A regular bike includes a pedal swing that encompasses three hundred and sixty degrees with a diametrically opposed pedal assembly 1100. Approximately one hundred and five degrees of a pedal swing is only partially efficient, as represented by the partially efficient zones (1310 and 1300). In these partially efficient zones approximately 20% to 30% of the total torque generated by a full pedal swing is generated. The least efficient zone 1400, also referred to as the recovery zone, generates approximately 0% to 20% of total torque. Skillful and experienced bikers can generate 20% torque in the recovery zone by pulling the pedal up. The remaining portion of the pedal swing is the most efficient zone 1500. Approximately 60% to 70% of the total torque generated by a full pedal swing is generated in the most efficient zone 1500.

In certain situations it may be beneficial to vary the length of the crank arm to provide more torque in the power zone, also referred as the down-stroke, of each pedal revolution by optimizing the length of each crank arm throughout the revolution of the crank assembly. The crank arm may fully collapse to the shortest length possible while the crank arm swings through the recovery zone, also referred as the up-stroke. The crank arm length immediately starts to extend to increase the amount of torque applied as the crank arm swings into the power zone. The crank arm may extend to the fully extended position to maximize the amount of torque applied as the crank arm swings through the power zone. Finally, the crank arm begins to collapse its length after the crank arm swings through the recovery zone. Yet in other situations it may be beneficial to optimize the crank arm length and rotating speed as the crank arm rotates about the spindle.

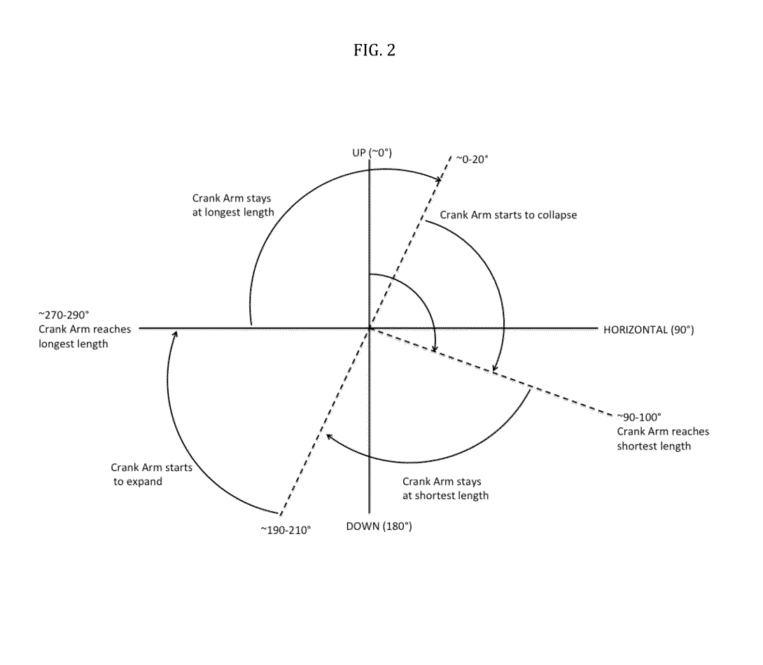

FIG. 2 illustrates an example in which the crank arm assembly length is optimized to rotate quickly through the most efficient zone and expand to the crank arm assembly's longest length as it passes through the least efficient zone. The crank arm starts at a range of about 0 to 20 degrees with the crank arm assembly fully extended such that the crank arm length is at its maximum. The crank arm assembly starts to collapse as it passes the range of about 0 to 20 degree zone. At a range of about 80 to 100 degrees the crank the crank arm assembly collapses to its shortest length. The crank arm assembly maintains the shortest length until it passes a range of about 180 to 210 degrees. At this point the crank assembly starts to expand until it reaches its longest length at a range of approximately 260 to 280 degrees. The crank arm maintains its longest length until it rotates past the 0 to 20 degree zone. The crank arm assembly again starts collapsing as it passes through the approximately 20 degree zone.

Most bicycles include crank arms with lengths between 165 and 175 mm, therefore the spinning span, or total distance from one center of the pedal axle to another is usually between 330 mm (165 mm×2) and 350 mm (175 mm×2). The angular speed of the crank arms are fastest when the crank arms are shortest, for example 165 mm. However, the amount of torque applied is greatest when the crank arm length is the longest, for example 175 mm. Since bicycles have fixed crank arms lengths, either the crank arm is assembled with short crank arms that increase the angular speed of the crank arm assembly, but with non-optimized torque; or, the crank arm assembly uses long crank arms with the optimum amount of torque, but with reduced rotational speed. Spinning spans over 350 mm or under 330 mm are considered impractical because they are less efficient and may cause discomfort and fatigue on most riders. This invention optimizes the crank arm length as the crank arm assembly rotates about the spindle by keeping the spinning span (length of left and right crank combined) constant as it rotates about the spindle. For example, when the right crank arm is at its longest the left crank arm is at its shortest. In fact, the sum of the left and right crank arms is always constant (e.g. 163 mm+185 mm=347 mm) regardless of the position.

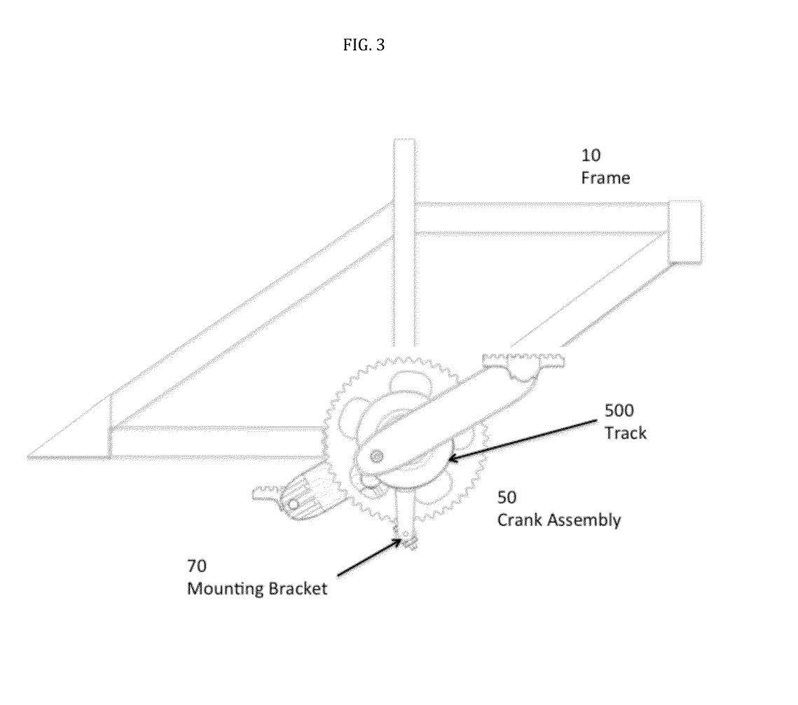

FIG. 3 illustrates a bicycle frame 10 with the crank assembly 50 designed to allow the length of the crank arms to vary as the crank arms rotate about the spindle. The invention is designed such that it can be used with existing bicycles. For example, the invention may be mounted to any bicycle frame 10. This invention could be provided as an accessory to existing bikes, as the crank assembly can be mated to of an existing bicycle frame, without interfering with the existing wheels, sprockets, brakes, shifters, or any other components. The invention is described as used with a three-piece crank assembly including a main spindle, and two crank arm assemblies. However, one skilled in the art will recognize that the invention may also be used with a single-piece crank assembly. The invention is novel because all of the components are designed to fit with an existing bicycle and with only a single attachment to the frame 10. The chain ring base, chain ring holder, bearings, crank arms, sliders, pedals, and chain ring are all attached to the spindle—which in turn is mated to the bicycle via the bottom bracket. The tracks are the only components attached to the frame.

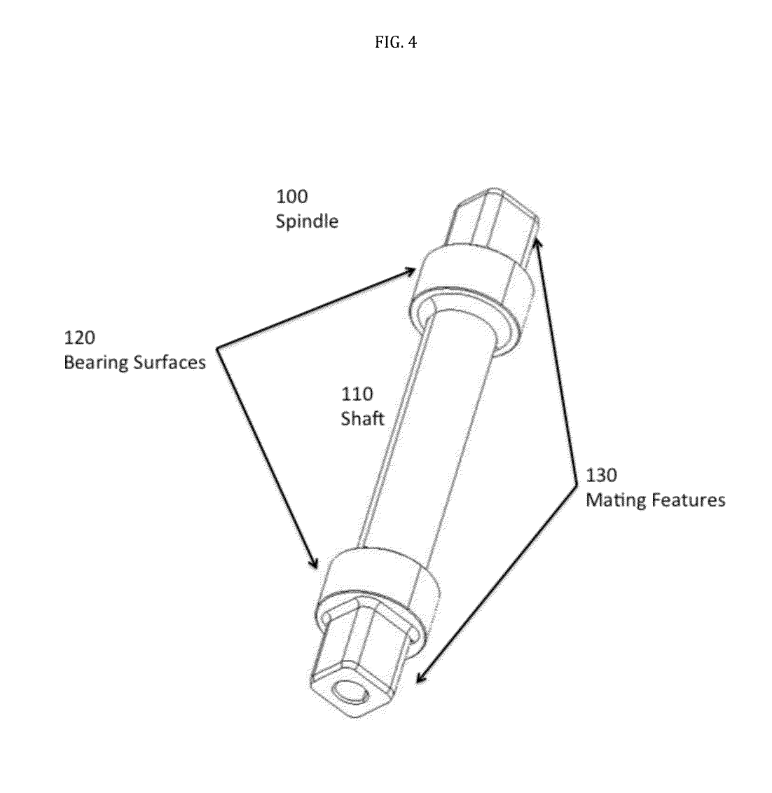

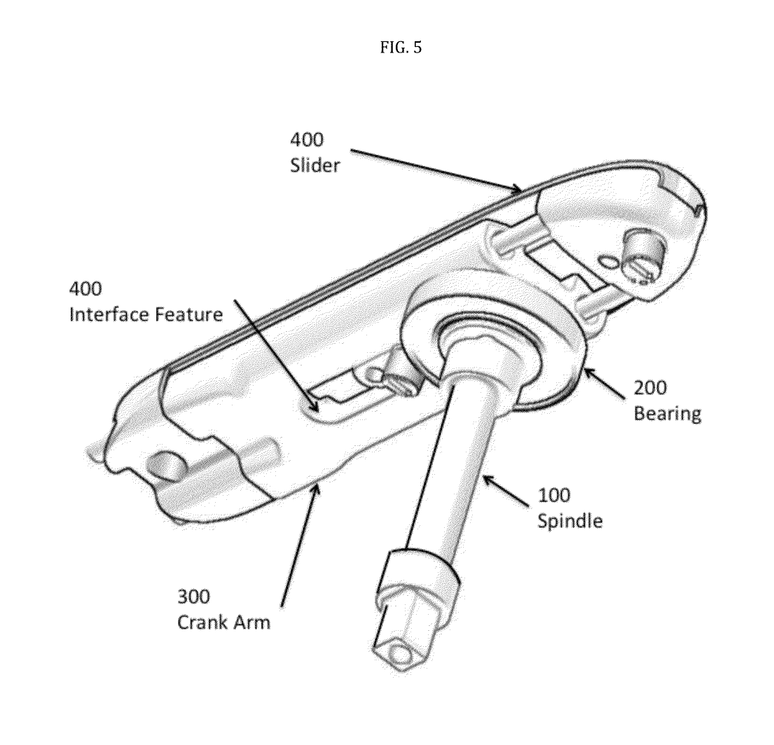

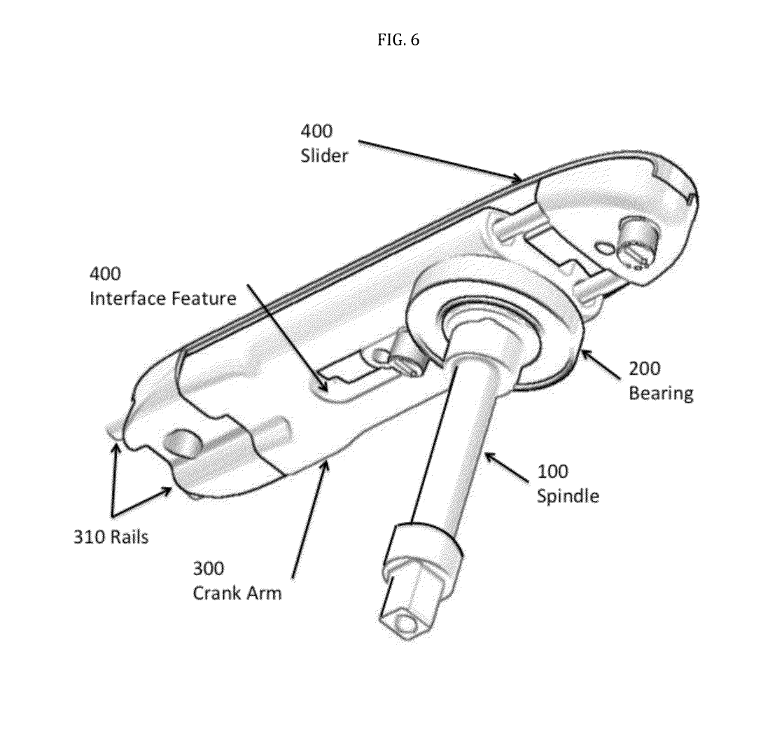

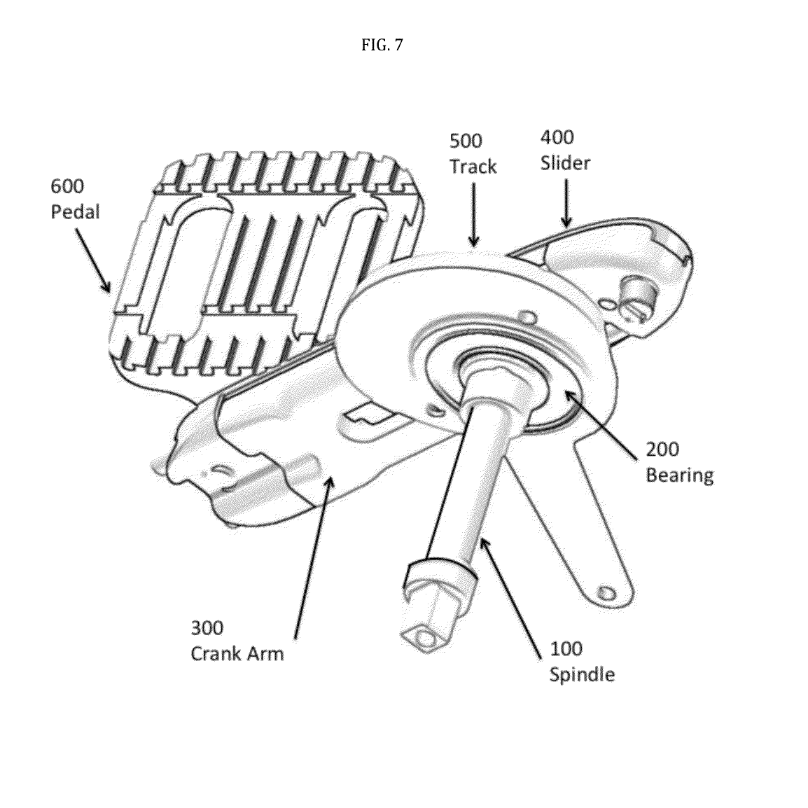

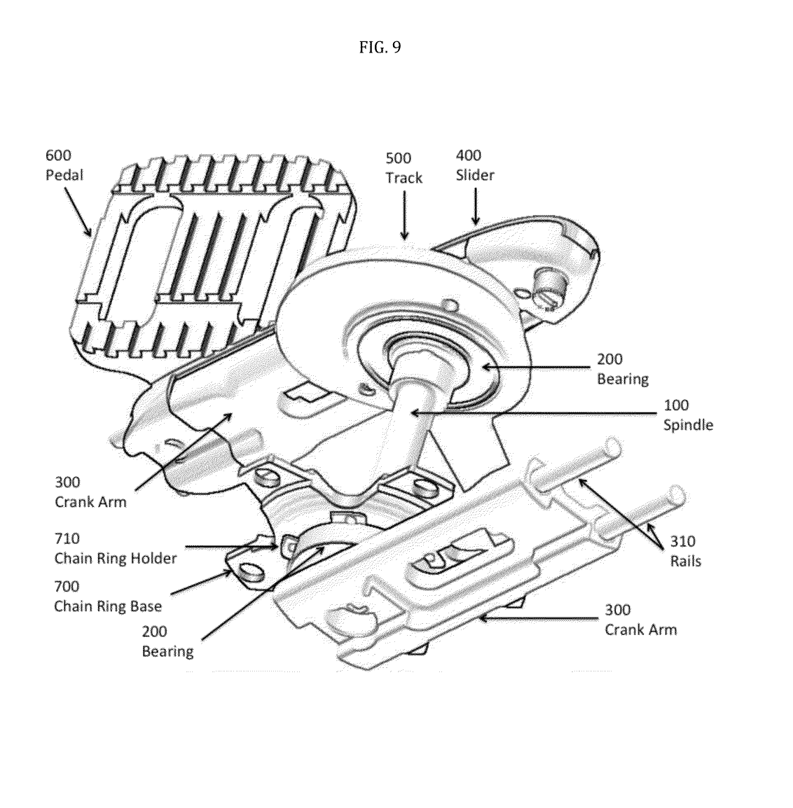

FIG. 4 illustrates the spindle 100. The spindle 100 is attached to the bottom bracket assembly of the bicycle. The spindle 100 is comprised of a cylindrical shaft 110 with a mating feature 130 at each end. All of the components are integrated with the bicycle via the spindle 100. The spindle 100 also includes a bearing surface 120 designed to interface with a bearing. FIG. 5 illustrates the first crank arm assembly (e.g. left crank arm assembly) attached to the spindle's left mating feature. The left crank arm assembly includes the crank arm 300, slider 400, bearing 200, track 500 (see FIG. 6), and pedal 600 (see FIG. 7). The crank arm 300 is attached to the spindle 100 via the mounting feature 130 (see FIG. 4) to mate to the spindle 100. The crank arm 300 includes fixed protruding rails 310 at one end of the crank arm (See FIG. 9, e.g. at the end opposite the spindle mounting feature). The other end of the crank arm (e.g. at the end near the spindle mounting feature) includes rail mating holes 340, which allow the rear roller support's fixed rails to expand and collapse relative to the crank arm 300. The rails 310 are formed from a predominately solid piece of material with smooth bearing surfaces, such as from solid cylindrical rods. The crank arm 300 also includes a bearing surface 330 sharing the same center of axis as the mating feature 130 used to mate the spindle 100. The bearing surface 330 is used to mate a bearing 200. The crank arm 300 also includes an interface feature 320 that may include an open slot so various components don't interfere with each other. For example, the interface feature 320 may include a slot with an opening distance equal to the amount that the slider 400 expands and collapses.

A bearing 200 is placed on the crank arm's bearing surface 330. The bearing 200 enables the tracks 500 to be assembled via the spindle 100 and remain fixed relative to the bicycle frame 10 when the crank arms 300 are rotated. The bearing 200 may include a cartridge bearing system typically used with bicycle bottom brackets. The track 500 is placed on the outside diameter surface of the bearing 200. The bearing 200 may be press fit onto the crank arm 300 and the track 500 may be press fit onto the bearing 200. As the crank arms 300 rotate the bearings 200 enable the track 500 to remain fixed relative to the frame 10. In other words, the tracks 500 do not rotate along with the crank arms 300 even though they are assembled to the crank arms 300. The track 500 is also attached to the frame 10 by the mounting brackets 70 shown in FIG. 3 which hold the tracks 500 fixed relative to the bicycle's frame 10.

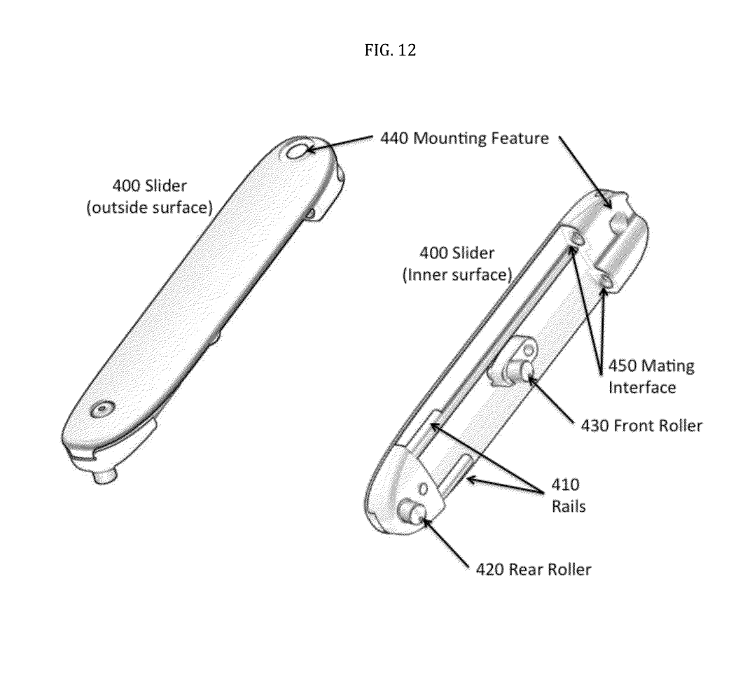

Next, the opposite end of the crank arm with the fixed rails is attached to the slider 400. As shown in FIG. 12, the slider 400 includes mating interfaces 450 that interact with the crank arm's fixed rails 310 and the roller support's fixed rails 410. The front roller 430 is attached near the mid-length of the slider 400 using a fastener. In addition, the rear roller 420 is attached at one end of the slider 400. The opposite end of the slider 400 includes a mounting feature 440 used to mate a user interface device, such as a pedal 600.

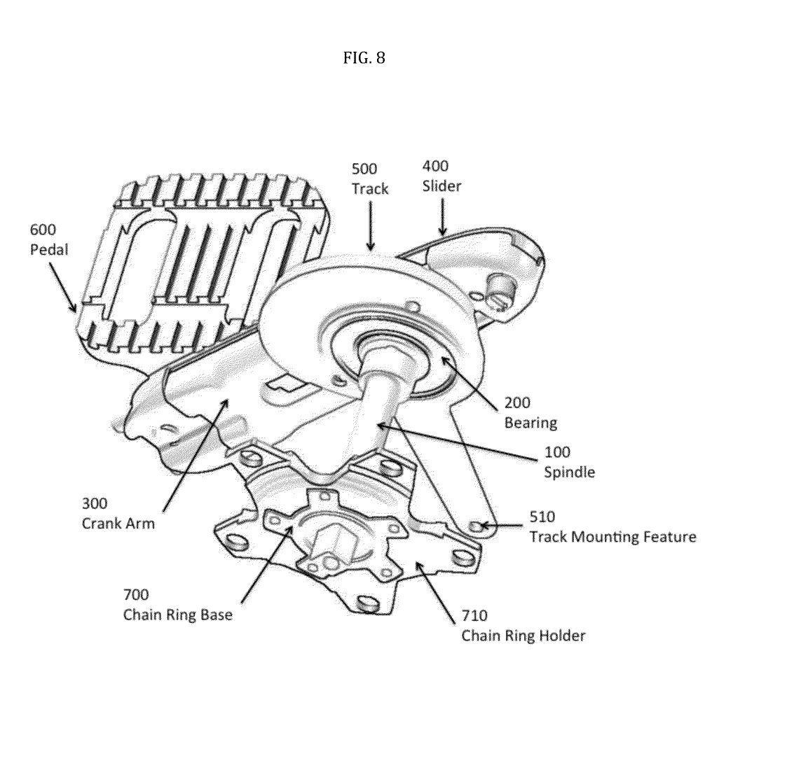

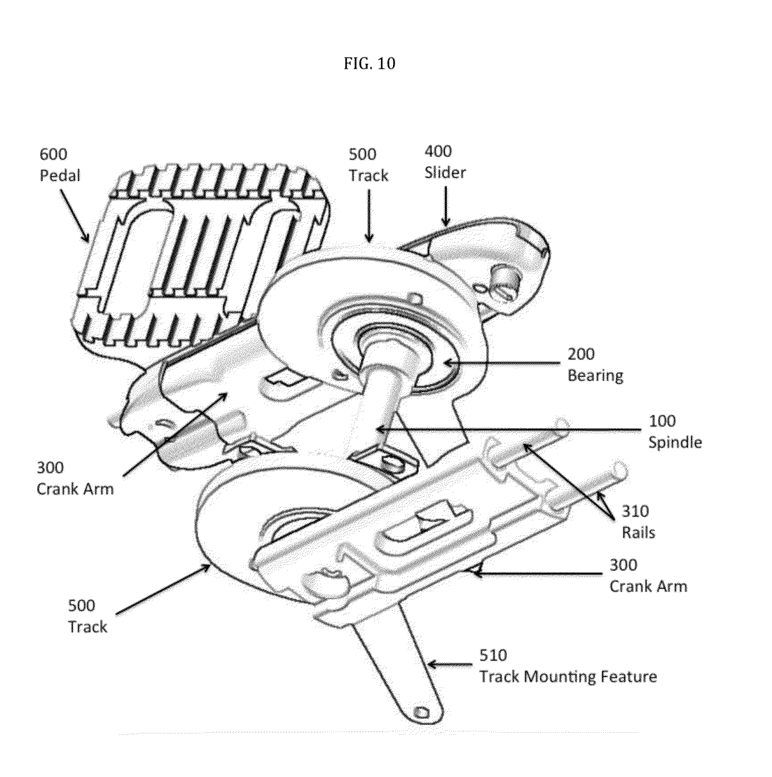

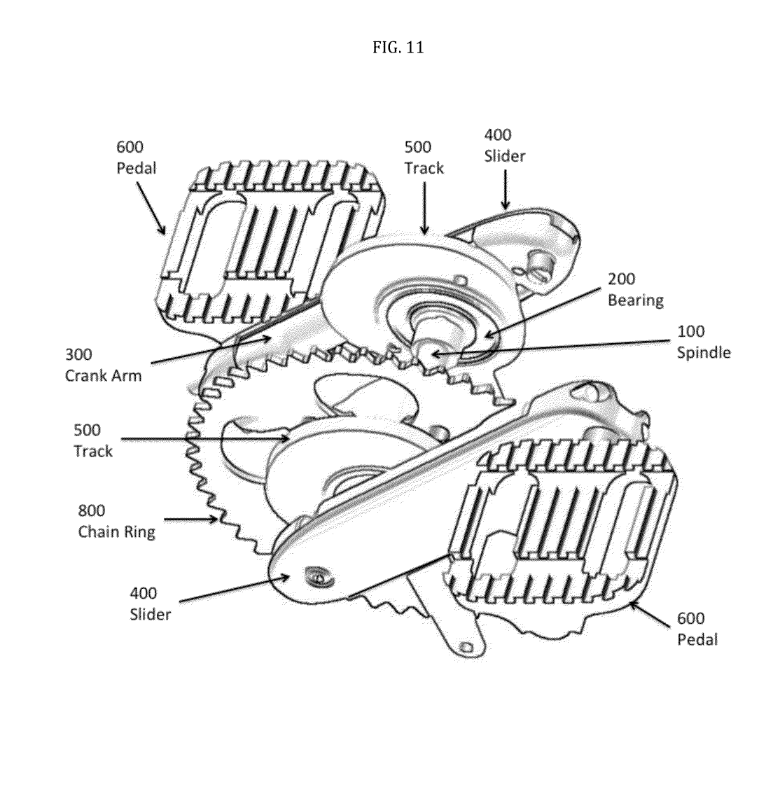

FIGS. 8, 9, 10, and 11 illustrate the second crank arm assembly (e.g. right crank arm assembly) attached to the spindle's right mating feature. The right crank arm assembly includes the chain ring base 700, chain ring holder 710, bearing 200, track 500, crank arm 300, slider 400, pedal 600, and chain ring 800. The right crank arm assembly is attached to the right end of the spindle. The crank arm 300 is attached to the spindle 100 via the mounting feature to mate to the spindle. The crank arm 300 includes fixed protruding rails 310 (shown clearly in FIG. 9) at one end of the crank arm (e.g. at the end opposite the spindle mounting feature). The other end of the crank arm (e.g. at the end near the spindle mounting feature) includes rail mating holes 340, which allow the rear roller support's fixed rails to expand and collapse. The rails 310 are formed from a predominately solid piece of material with smooth bearing surfaces, such as from solid cylindrical rods. The crank arm 300 also includes a bearing surface 330 sharing the same center of axis as spindle 100. The bearing surface 330 is used to mate a spinning bearing 200. The crank arm 300 also includes an interface feature 320 that may include an open slot so various components don't interfere with each other. For example, the interface feature 320 may include a slot with an opening distance equal to the amount that the slider 400 expands and collapses.

A bearing 200 (not shown but similar to the bearing used in the left crank arm assembly) is placed on the crank arm's bearing surface 330. The bearing 200 enables the tracks 500 to be assembled via the spindle 100 and remain fixed relative to the bicycle frame 50 when the crank arms 50 are rotated. The bearing 200 may include a cartridge bearing system typically used with bicycle bottom brackets. The track 500 is placed on the outside diameter surface of the bearing 200. The bearing 200 may be press fit onto the crank arm 300 and the track 500 may be press fit onto the bearing 200. As the crank arms 300 rotate the bearings 200 enable the track 500 to remain fixed relative to the frame 50. In other words, the tracks 500 do not rotate along with the crank arms 300 even though they are assembled to the crank arms 300. The track 500 is also attached to the mounting brackets 79 shown in FIG. 3 which hold the track 500 fixed relative to the bicycle's frame 50.

Next, the opposite end of the crank arm 300 with the fixed rails 310 is attached to the slider 400. The slider 400 includes mating interfaces 450 that interacts with the crank arm's fixed rails 310 and the roller support's fixed rails 410. The front roller 430 is attached near the mid-length of the slider 400 using a fastener. In addition, the rear roller 420 is attached at one end of the slider 400. The opposite end of the slider 400 includes a mounting feature 440 used to mate a user interface device, such as a pedal 600.

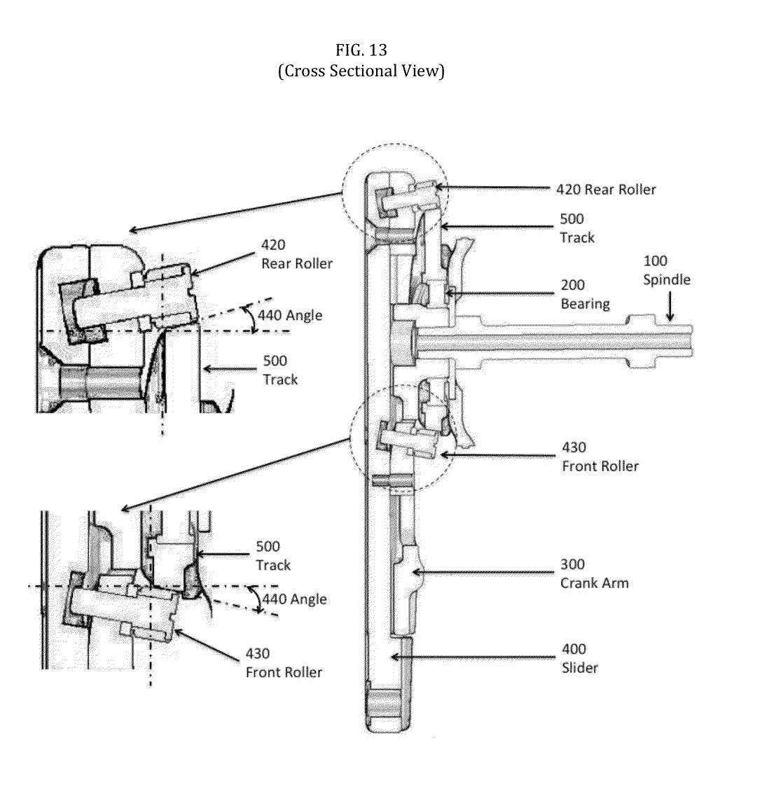

The slider 400 includes mating features 450 to interface with the crank arm's rails 310. The mating surface 450 may include through holes which enable the rails 310 to slide in and out of as the crank arm assembly expands and collapses. In addition, the slider 400 includes a rear roller 420 and front roller 430 mounted to the inner surface of the slider 400. The rollers 420 and 430 are designed to interface with the track 500 to minimize frictional forces. The rollers 420 and 430 and track 500 are designed with an interface angle 440, as shown in the close up views of FIG. 13 of approximately 10 degrees. This interface angle 440 is optimized to reduce friction effects and unnecessary lateral motion of the crank arm caused by the pedal 600 never being coaxial with the cross-section of the crank arm 300. The manner in which the force is applied to the pedal 600 induces a side load into the crank assembly with a resulting friction that could reduce the benefits of this invention. The interface angle 440 of the rollers and track are tilted about 10 degrees to reduce the frictional forces. The rollers 420 and 430 are designed to run freely along the outside diameter surface of the tracks 500 and guide the crank arm assemblies along the track 500 such that the overall length of the crank arm assembly can vary from the collapsed to extended positions as the crank arm assembly rotates through each revolution.

Weight-to-strength ratio is an important design consideration for several potential uses of this invention, such a bicycle design. As such, each of the components referenced in this invention are designed in a manner to optimize the strength-to-weight ratio to minimize the amount of weight added to the assembly. For example, the components may be made using a hollow geometries, such as a hollow shaft, and/or be made of materials with optimum strength-to-weight ratios such as aluminum, chrome alloys, steel alloys, titanium, carbon fiber, and the like.

FIG. 3 illustrates a bicycle frame 10 with the crank assembly 50 designed to allow the length of the crank arms of the crank assembly 50 to vary as the crank arms rotate about the spindle 100. The invention is designed such that it can be used with existing bicycles. For example, the invention may be mounted to any bicycle frame and spindle assembly. This invention could be provided as an accessory to existing bikes, as the crank assembly can be mated to of an existing bicycle frame, without interfering with the existing wheels, sprockets, brakes, shifters, or any other components. The invention is described as used with a three-piece crank assembly including a main spindle, and two crank arm assemblies. However, one skilled in the art will recognize that the invention may also be used with a single-piece crank assembly.

In the preferred embodiment, the rails consist of two cylindrical rods. The rails comprise predominately solid pieces of material with at least two smooth bearing surfaces. To optimize the weight the geometry of the rails may include through holes, or gussets to optimize the strength to weight ratio needed for associated loads and stresses. The cross sectional geometry of the rails may also be formed with different geometries. For example, the cross sectional geometry may be rectangular, square, round, or oval. In addition, the rails may be permanently fixed to the crank arm 300 and slider 400. In fact, the rails 310 and crank arm 300 and rails 410 and slider 400 may be fabricated from a single process such as being machined from a single block of material, or formed as a single piece from a mold. Alternatively, the rails 310 and 410 may be replaceable. For example, the rails 310 and 410 may be attached with fastening features. In this configuration, the rails 310 and 410 may be exchanged with a different length rails to allow the overall crank assembly to change. Also the tracks 500 would be replaced with a different geometry track to accommodate the different crank assembly. This may be beneficial for riding in different terrains or with different riders, such as the optimum crank lengths for a child may be different for an adult.

The tracks 500 are mounted to the frame 50 with a mounting brackets 70. The mounting bracket 70 and tracks 500 are designed in a way such that they can be removed from the frame 10. The mounting bracket 70 and tracks 500 are designed such that they can be easily installed or removed from an existing frame 10. The mounting bracket 70 also includes fastening features that allow the tracks 500 to be mounted to the mounting brackets 70. The tracks 500 are used to control the length of the crank arms at each angular position. The shape of each track 500 is designed to coincide with the optimum crank arm length at the various angular positions as the crank arm rotates through a complete revolution. For example, the tracks geometry may take on an oblong elliptical shape with the major diameter coinciding with the crank arms motion through the least efficient zone.

The terms and expressions, which have been employed herein, are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A crank assembly comprising:
a spindle with a mating feature at each end;
a first crank arm assembly attached to the spindle's left mating feature, wherein the first crank arm assembly comprises a crank arm, slider, bearing, track, and pedal;
a second crank arm assembly attached to the spindle's right mating feature, wherein the second crank arm assembly includes a chain ring base, chain ring, bearing, track, crank arm, slider, and pedal; and
wherein the geometry of the track controls the crank assembly fully extending the length of each crank arm assembly to the longest length in the down-stroke of each revolution and collapsing each crank arm assembly to the shortest length in the up-stroke of each revolution.

2. The crank assembly of claim 1, wherein the total length of the crank assembly is kept constant while the crank assembly rotates and the length of the first and second crank arm assemblies extend and collapse.

3. The crank assembly of claim 1, wherein the total length of the crank assembly is at about 350 mm.

4. The crank assembly of claim 1, wherein the shortest length of the crank arm and slider together is about 165 mm.

5. The crank assembly of claim 1, wherein the longest length of the crank arm and slider together is about 185 mm.

6. A crank assembly comprising:
a spindle with a mating feature at each end;
a first crank arm assembly attached to the spindle's left mating feature, wherein the first crank arm assembly comprises a crank arm, slider assembly, bearing, track, and pedal; and
a second crank arm assembly attached to the spindle's right mating feature, wherein the second crank arm assembly includes a chain ring base, chain ring, bearing, track, crank arm, slider, and pedal; and
wherein the geometry of the track controls the crank assembly collapsing the length of each crank arm assembly from the longest length at about the beginning of the down-stroke, to the shortest length at about the end of the down-stroke of each revolution, and fully extending the crank arm assembly back again to the longest length at about the end of the up-stroke of each revolution.

7. The crank assembly of claim 6, wherein each crank arm assembly starts to collapse as it passes the range of about 0 to 20 degrees, the crank arm assembly collapses to its shortest length at a range of about 80 to 100 degrees, the crank arm assembly maintains the shortest length until it passes a range of about 180 to 210 degrees, the crank arm assembly starts to expand until it reaches its longest length at a range of about 260 to 280 degrees, and the crank arm maintains its longest length until it rotates past the range of about 0 to 20 degrees.

8. A crank assembly designed to control the varying length of crank arm assemblies as the crank assembly rotates about a spindle comprising:
a spindle with a mating feature at each end;
a first crank arm assembly attached to the spindle's left mating feature, wherein the first crank arm assembly comprises a crank arm, slider, bearing, track, and pedal; and
a second crank arm assembly attached to the spindle's right mating feature, wherein the second crank arm assembly includes a chain ring base, chain ring, bearing, track, crank arm, slider, and pedal.

9. The crank assembly of claim 8, wherein the chain ring base, bearings, crank arms, sliders, pedals, and chain ring are all attached via the spindle and are coaxial with the spindle.

10. The crank assembly of claim 8, wherein the crank assembly is attached to a bicycle frame.

11. The crank assembly of claim 8, comprising crank arms with fixed rails at the end opposite the spindle's mounting feature, wherein the rails are formed from a material with smooth bearing surfaces.

12. The crank assembly of claim 8, comprising crank arms with fixed rails at the end opposite the spindle's mounting feature, wherein the rails are formed from two round rods positioned on a parallel orientation to each other.

13. The crank assembly of claim 8, wherein the crank arm, at the end near the spindle's mounting feature, includes rail-mating holes with sleeves that are formed from a material with smooth bearing surfaces that allow the slider's fixed rails to expand and collapse.

14. The crank assembly of claim 8, comprising sliders that include rail mating holes with fixed sleeves at the end far from the spindle, wherein the sleeves are formed from a material with smooth bearing surfaces that allow the crank arm's fixed rails to expand and collapse.

15. The crank assembly of claim 8, wherein the crank arm includes a bearing surface used to mate a bearing, with the tracks mounted on the outside diameter of the bearing to enable the tracks to remain fixed relative to the frame when the crank assembly rotates.

16. The crank assembly of claim 8, wherein the track is attached to the frame by mounting brackets, which holds the track fixed relative to the frame.

17. The crank assembly of claim 8, wherein the end of the crank arm with the fixed rails is attached to the slider.

18. The crank assembly of claim 8, wherein the slider includes mating interfaces that interact with the crank arm's fixed rails and the rear roller's fixed rails.

19. The crank assembly of claim 8, wherein the sliders include a front roller and a rear roller attached to the inner side of the slider.

20. The crank assembly of claim 19, wherein the front roller, rear rollers, and track include an interface angle.

21. The crank assembly of claim 20, wherein the interface angle is approximately 10 degrees.

22. The crank assembly of claim 19, wherein the front and rear rollers are designed to run freely along the outside surface of the tracks to guide the crank arm assembly along the track such that the overall length of the crank arm assembly can vary from the collapsed to extended positions as the crank arm assembly rotates.

23. The crank assembly of claim 8, wherein the bearing is assembled between the crank arm and the track enabling the crank assembly to be mounted coaxially on the spindle.
